(19) United States
(12) Patent Application Publication
(10) Pub. No.: US 2011/0145607 A1
(43) Pub. Date: Jun. 16, 2011

(54) INFORMATION PROCESSING APPARATUS AND ENERGY-CONSUMPTION CONTROL METHOD

(76) Inventors: Takeshi Watakabe, Ome-shi (JP); Makoto Taki, Ome-shi (JP)

(21) Appl. No.: 12/963,494

(22) Filed: Dec. 8, 2010

(30) Foreign Application Priority Data
Dec. 11, 2009 (JP) JP 2009-282111

(51) Int. Cl. G06F 1/32

(52) U.S. Cl. 713/310

(57) ABSTRACT

According to one embodiment, an information processing apparatus connectable to a client terminal comprises a storage, acquisition module, read module, and control module. The storage stores energy-consumption setting information of the client terminal in association with information relating to the client terminal. The acquisition module acquires client terminal information from the client terminal. The read module reads the information relating to the client terminal from the storage based on the acquired client terminal information, and to read the energy-consumption setting information in association with the information relating to the client terminal. The control module delivers the read energy-consumption setting information to the client terminal in order to carry out an energy consumption control for the client terminal.

### CROSS-REFERENCE TO RELATED APPLICATIONS

This application is based upon and claims the benefit of priority from Japanese Patent Application No. 2009-282111, filed Dec. 11, 2009; the entire contents of which are incorporated herein by reference.

### FIELD

Embodiments described herein relate generally to an information processing apparatus configured to carry out energy-saving setting of a client terminal connectable to a server apparatus, and energy-consumption control method to be applied to the apparatus.

### BACKGROUND

In recent years, it is required to unitarily manage energy-saving setting statuses of PCs utilized in a corporate system from the utilization supervisor side in order to adapt the system to green IT of the information system. Operational management software configured to deliver or apply information for energy-saving setting to client PCs already exists. In a system including a server apparatus and client terminals connectable to the server apparatus, a technique configured to set an energy-saving status of a client terminal by means of the server apparatus is disclosed in, for example, Jpn. Pat. Appln, KOKAI Publication No. 2007-317054. In this, publication, an information platform apparatus configured to limit the amount of energy consumed by a processing module constituting a logic device is disclosed. However, in the information platform apparatus described in the patent publication, when a configuration request is received from a logic device, a processing module constituting the logic device associated with the configuration request is selected by referring to device configuration information indicative of a correspondence relationship between the logic device and processing module constituting the logic device, the correspondence relationship being stored in advance, and calculation of a first energy amount used to operate the logic device is carried out based on a type of logic device included in the configuration request, operation condition of the logic device included in the configuration request, and energy amount management information.

Furthermore, it is necessary to carry out calculation of a second amount of energy to be supplied to the processing module based on the calculated first energy amount, and information on the processing module constituting the logic device. Accordingly, there is the problem that the processing load of the information platform apparatus becomes heavy.

In order to confirm an effect of the energy-saving setting, it is necessary to investigate and input the energy consumption of each PC. However, inputting energy consumption for each of all the PCs by the user involves the drawback that the labor of the supervisor becomes enormous. Although a method of uniformly defining the energy consumption of the PC is also conceivable for the purpose of labor saving, energy saving of PCs is advanced every year, and hence appropriate numerical conversion of the effect cannot be carried out by substituting a uniform numerical value for energy consumption of the PCs in the corporate system.

Further, in the existing operational management software, there is a problem that it is not possible to previously predict the degree of effect that can be expected when the set value of the energy-saving setting is changed.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary view showing the configuration of an energy-consumption control system including an information processing apparatus according to a first embodiment.

FIG. 2 is an exemplary block diagram showing the system configuration of a policy delivery server of the first embodiment.

FIG. 3 is an exemplary block diagram showing the system configuration of an energy-consumption control application of the policy delivery server, agent of a client terminal, and database update server of the first embodiment.

FIG. 4 is an exemplary flowchart showing the processing of an energy-consumption control method according to the first embodiment.

FIG. 5 is an exemplary view schematically showing the energy-saving policy according to the first embodiment.

FIG. 6 is an exemplary view schematically showing an energy-saving measurement log transmitted from the client terminal to the server apparatus according to the first embodiment.

FIG. 7 is an exemplary flowchart showing the processing of energy-consumption control of the client terminal according to the first embodiment.

FIG. 8 is an exemplary view schematically showing an example of an energy-consumption database of the server apparatus according to the first embodiment.

FIG. 9 is an exemplary view schematically showing a CPU performance search list in the energy-consumption database of the server apparatus according to the first embodiment.

FIG. 10 is an exemplary view schematically showing a list of energy-consumption data (energy-consumption value) in the energy-consumption database of the server apparatus according to the first embodiment.

FIG. 11 is an exemplary view showing a totalizing method for the time in which an energy-saving function is operative from log information stored in an energy-saving measurement log storage area based on the energy-saving policy.

FIG. 12 is an exemplary view schematically showing a case where an actual energy-saving result (separate confirmation screen of an actual energy-saving result) is formed into a graph.

FIG. 13 is an exemplary view schematically showing a case where an energy-saving prediction (separate prediction analysis confirmation screen of an energy-saving plan) is formed into a graph.

FIG. 14 is an exemplary view showing the configuration of an energy-consumption control system including an information processing apparatus according to a second embodiment.

FIG. 15 is an exemplary view schematically showing a concept of an energy-saving policy used in the server apparatus of the second embodiment.

FIG. 16 is an exemplary view schematically showing a concept of an effect threshold used in the server apparatus of the second embodiment.

FIG. 17 is an exemplary flowchart showing the processing of an energy-consumption control method used in the server apparatus according to the second embodiment.

### DETAILED DESCRIPTION

Various embodiments will be described hereinafter with reference to the accompanying drawings.

In general, according to one embodiment, according to one embodiment, an information processing apparatus connectable to a client terminal comprises a storage, acquisition module, read module, and control module. The storage stores energy-consumption setting information of the client terminal in association with information relating to the client terminal. The acquisition module acquires client terminal information from the client terminal. The read module reads the information relating to the client terminal from the storage based on the acquired client terminal information, and to read the energy-consumption setting information in association with the information relating to the client terminal. The control module delivers the read energy-consumption setting information to the client terminal in order to carry out an energy consumption control for the client terminal.

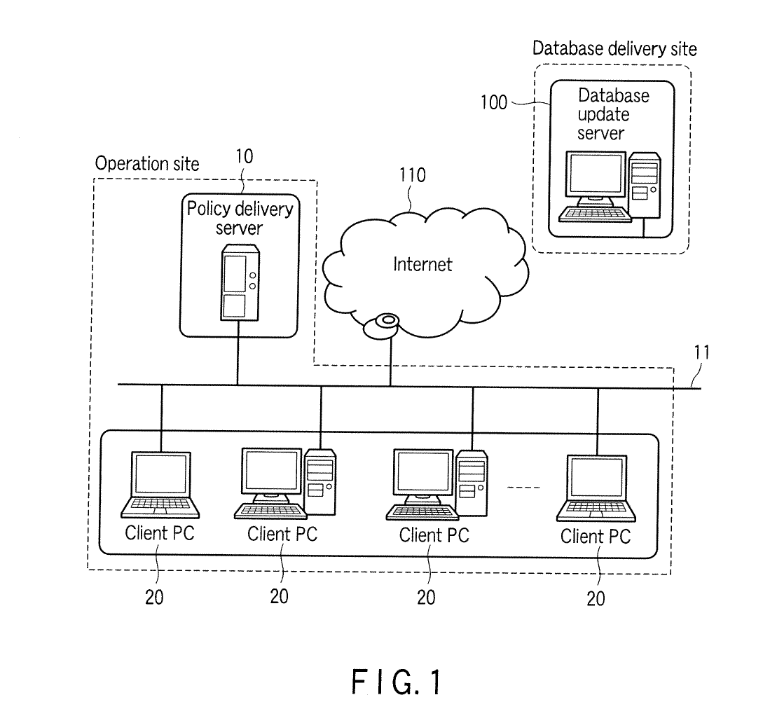

The configuration of an energy-consumption control system according to a first embodiment will be described below with reference to FIG. 1. The energy-consumption control system comprises, for example, a policy delivery server 10. A client terminal connected to the server 10 comprises, for example, a client PC 20 which is a personal computer (PC) or the like.

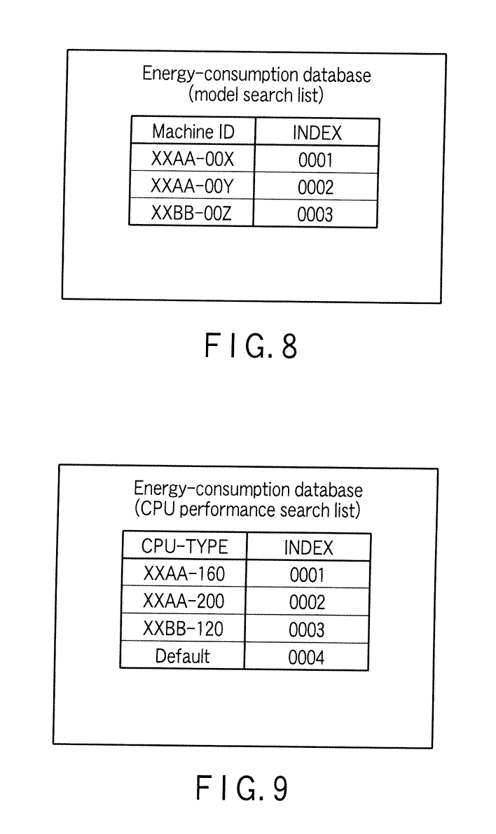

The energy-consumption control system comprises an operation site and database delivery site which are indicated by ranges surrounded by dotted-lines. The operation site comprises the policy delivery server 10 and a plurality of client PCs 20 which can be connected to the policy delivery server 10 through a network such as a Local Area Network (LAN) 11 or the like. The database delivery site comprises a database update server 100. When the database update server 100 is accessed by the policy delivery server 10 through a network such as the Internet 110 or the like, the database update server 100 delivers (downloads) an energy-consumption database (FIGS. 8, 9, and 10) which is updated data of the database to the policy delivery server 10.

The policy delivery server 10 comprises a computer in which management software is installed. The policy delivery server 10 comprises a function of inputting information for energy-saving setting to be described later, and energy-consumption database (FIGS. 8 to 10). The database update server 100 updates the energy-consumption database (to be described later) of the policy delivery server 10. It should be noted that the update of the energy-consumption database is not limited to the update through the network as described above, and may be carried out by directly loading the updated data into the policy delivery server 10 by using a storage medium or the like.

Agent software configured to realize an energy-saving state based on information used for energy-saving setting received from the policy delivery server 10 is installed in the client PC 20. It is assumed that in the example, the group of PCs comprises n client PCs.

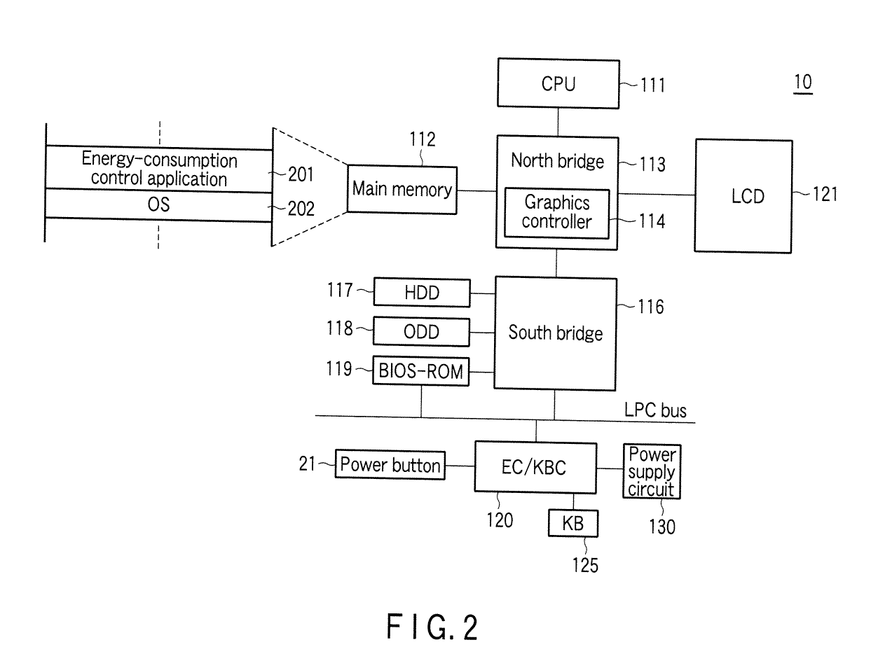

Next, the system configuration of the policy delivery server 10 will be described below with reference to FIG. 2.

The policy delivery server 10 comprises a CPU 111, north bridge 113, graphics controller 114, main memory 112, LCD 121, south bridge 116, hard disk drive (HDD) 117, optical disk drive (ODD) 118, BIOS-ROM 119, embedded controller/keyboard controller IC (EC/KBC) 120, keyboard (KB) 125, power supply circuit 130, and the like.

The CPU 111 comprises a processor configured to control an operation of the policy delivery server 10, and executes various application programs such as an operating system (OS) 202, and energy-consumption control application program 201 (hereinafter referred also to an energy-consumption control application) which are loaded from the hard disk drive (HDD) 117 into the main memory 112. The energy-consumption control application program 201 is a software configured to store in advance an energy-saving policy in one-to-one correspondence with information (model name, type of CPU) on each client PC 20 under the control of the CPU 111, acquire log information (also referred to as an energy-saving measurement log) which is information on the client PC 20 from the client PC 20, acquire a model name and a type of CPU of the client PC 20 based on the acquired log information on the client PC 20, read the energy-saving policy associated with the model name and the type of CPU of the client PC 20, and deliver the read energy-saving policy to the client PC 20 to carry out control of the energy consumption of the client PC 20.

The north bridge 113 is configured to connect a local bus of the CPU 111 and south bridge 116 to each other. A memory controller configured to access-control the main memory 112 is incorporated in the north bridge 113. Further, the north bridge 113 has also a function of executing communication with the graphics controller 114.

The graphics controller 114 is a display controller configured to control the LCD 121 used as a display monitor of the policy delivery server 10. A display signal generated by the graphics controller 114 is transmitted to the LCD 121.

The south bridge 116 controls each device or the like on a Low Pin Count (LPC) bus. Further, an Integrated Drive Electronics (IDE) controller configured to control the hard disk drive (HDD) 117 and ODD 118 is incorporated in the south bridge 116.

The embedded controller/keyboard controller IC (EC/KBC) 120 comprises a one-chip microcomputer into which an embedded controller configured to manage power, and keyboard controller configured to control a keyboard (KB) 125 are integrated.

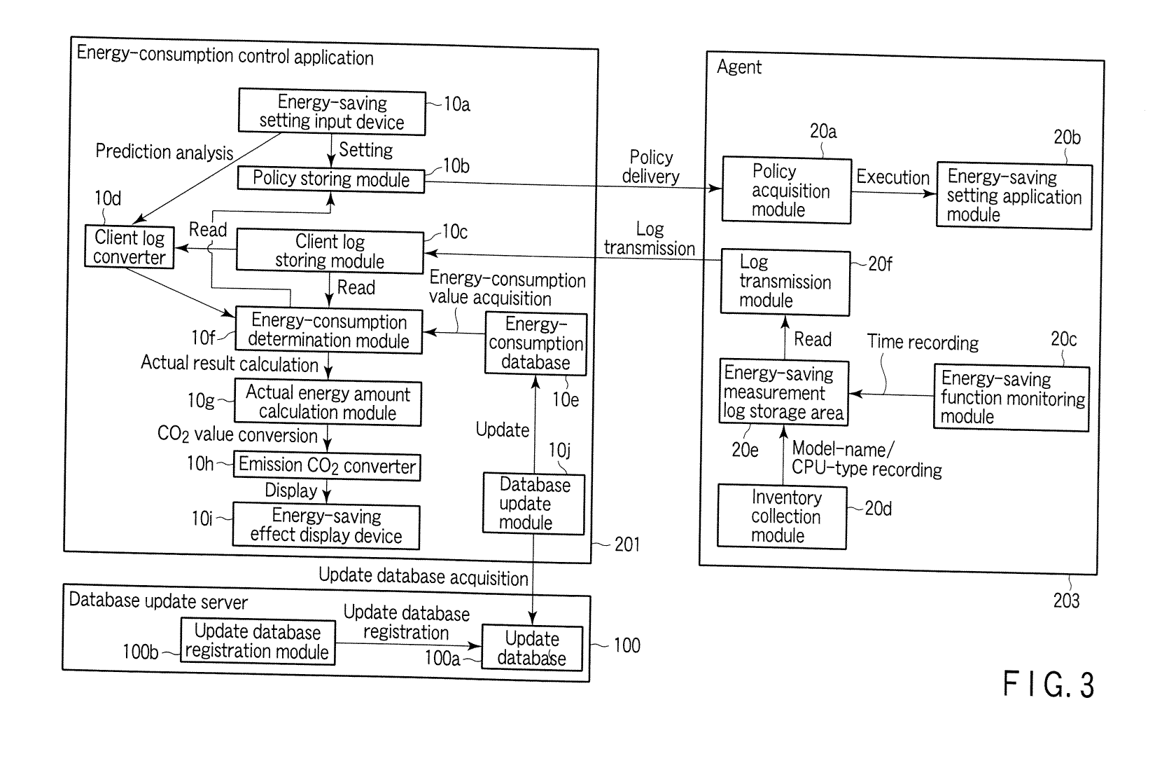

Next, the system configurations of the energy-consumption control application 201 of the policy delivery server 10, an agent 203 of the client PC 20, and the database update server 100 will be described below with reference to FIG. 3.

The energy-consumption control application 201 comprises an energy-saving setting input device 10a, policy storing module 10b, client log storing module 10c, client log converter 10d, energy-consumption determination module 10f, actual energy amount calculation module 10g, emission CO2 converter 10h, energy-saving effect display device 10i, and database update module 10j.

The energy-saving setting input device 10a is configured to input information used by the user to carry out energy-saving setting. The policy storing module 10b stores a set value input and determined by the energy-saving setting input device 10a as data of the energy-saving policy for delivery. The client log storing module 10c stores and manages log information transmitted from an agent of each client PC 20 to the policy delivery server 10. The client log converter 10d reads the actual operation result which is log information of each client PC 20, and calculates a predicted energy-consumption amount or the like in a case where an energy-saving set value is applied to the client PC 20 for the purpose of prediction/analysis of the energy-saving set value (energy-saving policy). The energy-consumption determination module 10f searches an energy-consumption database 10e based on log information of each client PC 20, and determines the energy consumption (energy-saving policy) of a client PC 20 which is an object of energy-saving setting. The energy-consumption determination module 10f stores the determined energy consumption (energy-saving policy) in the policy storing module 10b as an energy-saving policy to apply the energy consumption to a corresponding client PC 20. The energy-consumption database 10e is a table used to determine the energy consumption by using a model name or a CPU type of a client PC 20 as a key (to be described later). The actual energy amount calculation module 10g calculates the energy consumption based on the energy consumption determined by means of the energy-consumption database 10e and actual operation time of the log information. The emission CO₂ converter 10h converts the energy-consumption amount calculated by the actual energy amount calculation module 10g into a CO₂ emission amount. The energy-saving effect display device 10i forms the above-mentioned energy-consumption amount and CO₂ emission amount into a graph, and displays the graph. The database update module 10j accesses the database update server 100 and, when new PC energy-consumption database data is found, downloads the database data to update the energy-consumption database 10e.

The agent 203 (client PC 20) comprises a policy acquisition module 20a, energy-saving setting application module 20b, energy-saving function monitoring module 20c, inventory collection module 20d, energy-saving measurement log storage area 20e, and log transmission module 20f. The policy acquisition module 20a accesses the policy delivery server 10 to acquire an energy-saving policy to be stored in the policy storing module 10b through the LAN 11. The energy-saving setting application module 20b applies energy-saving setting to a client PC 20 in accordance with the energy-saving policy acquired by the policy acquisition module 20a. The energy-saving function monitoring module 20c monitors the fact or the like that an energy-saving function such as monitor-off or the like has been exerted or canceled in accordance with an instruction from the operating system, and records the time in the energy-saving measurement log. That is, the energy-saving function monitoring module 20c acquires log information which is the actual operation result of the client PC 20, and transmits the acquired log information to the energy-saving measurement log (storage area) 20e. For example, the energy-saving function monitoring module 20c detects the monitor-on time, monitor-off time, HDD motor-off time, HDD motor-on time, system-startup time, shutdown time, system-standby start time, restoration time, system-pause start time, and restoration time of the client PC 20. Further, the energy-saving function monitoring module 20c monitors a keyboard operation and mouse operation carried out by the user of the client PC 20, and detects the user non-operation start time and non-operation end time in units of minutes. The inventory collection module 20d acquires the model name of the client PC 20, and type of CPU incorporated therein from the operating system, and transmits the acquired name and type to the energy-saving measurement log (storage area) 20e as log information. The energy-saving measurement log (storage area) 20e stores therein the log information (energy-saving measurement log) acquired by the energy-saving function monitoring module 20c and inventory collection module 20d. The energy-saving measurement log is information in which the model name and the CPU type of the PC, and time at which the energy-saving function is exerted are recorded. The log transmission module 20f transmits the log information described in the energy-saving measurement log (storage area) 20e to the policy delivery server 10 through the LAN 11, for example, periodically. It should be noted that the log transmission module 20f may transmit the log information to the policy delivery server 10 in response to a request from the policy delivery server 10.

The database update server 100 comprises an update database 100a, and update database registration module 100b. The update database 100a stores therein a PC energy-consumption database registered by the update database registration module 100b. The energy-consumption database stored in the update database 100a can be accessed and downloaded by, for example, the database update module 10j of the policy delivery server 10. The update database registration module 100b registers a new PC energy-consumption database in accordance with an input of the keyboard, mouse, and the like.

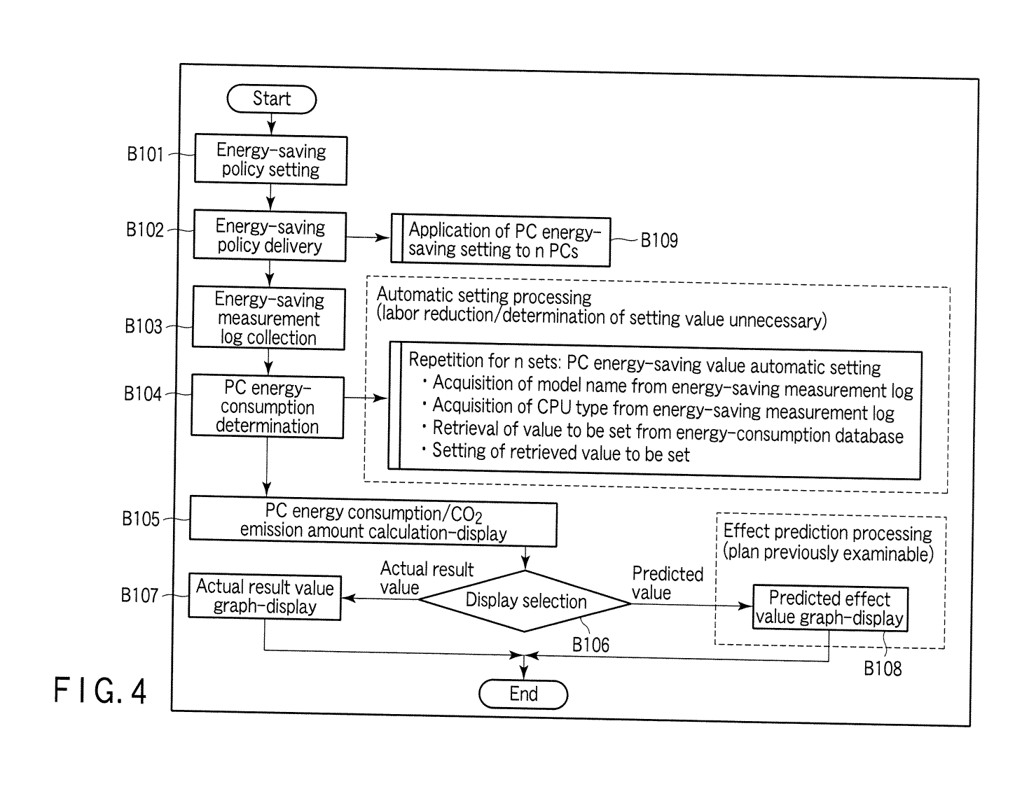

Next, FIG. 4 is a flowchart showing processing of an energy consumption control method (energy-saving setting method).

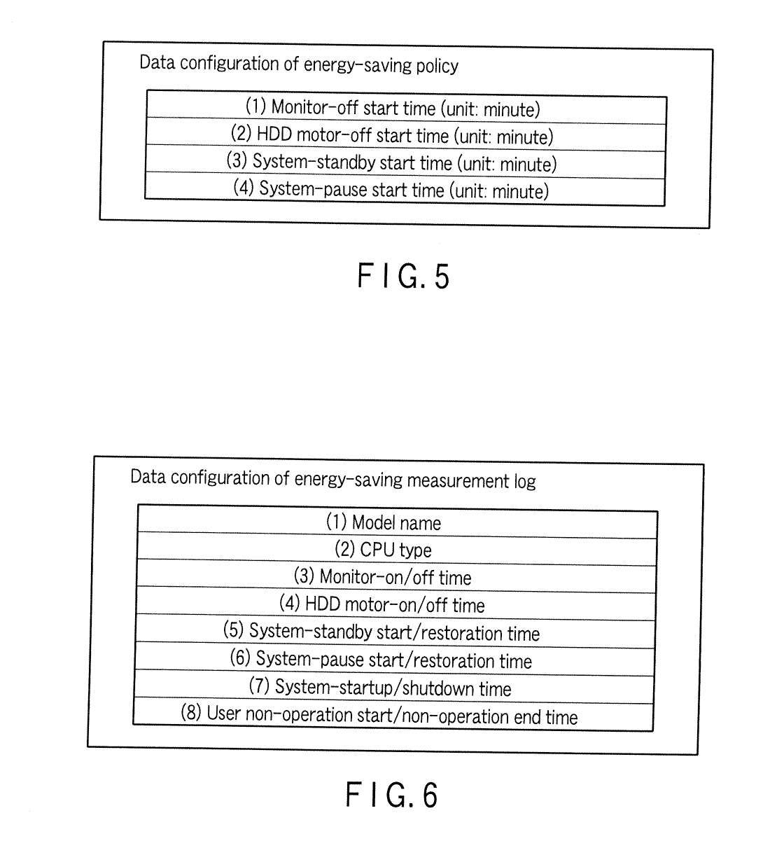

First, at the operation start time of the energy-consumption control system, the supervisor carries out setting of the energy-saving state (block B101). The collection of set values for various setting items is called an energy-saving policy. The data configuration of an energy-saving policy is shown in FIG. 5. It is assumed here that the data comprises four items. That is, the items comprises (i) monitor-off start time (minimum unit: minute), (ii) HDD motor-off start time (minimum unit: minute), (iii) system-standby start time (minimum unit: minute), and (iv) system-pause start time (minimum unit: minute).

The monitor-off start time denotes a specified time in a rule in which when there is no user operation for the specified time, the monitor power supply is to be turned off. The HDD motor-off start time denotes a specified time in a rule in which when there is no disk access for the specified time, the HDD motor is to be stopped. The system-standby start time denotes a specified time in a rule in which when a client PC 20 is in an idle state for the specified time, the client PC 20 is to be shifted to a standby state. The system-pause start time denotes a specified time in a rule in which when a client PC 20 is in an idle state for the specified time, the client PC 20 is to be shifted to a paused state.

It should be noted that although in the above-mentioned example, the four items are made the objects of the energy-saving control of the client PC 20, it is sufficient if the items are items which can be controlled, and execution of which can be detected, and the number of items, and item contents are not limited.

As described above, after the energy-saving policy is set in block B101, the energy-consumption control application 201 of the policy delivery server 10 delivers the energy-saving policy to the agent 203 of the client PC 20 (block B102). The energy-saving policy is delivered to the agent 203 of each of n client PCs 20 by the energy-consumption control application 201. Upon receipt of the energy-saving policy, the agent 203 of each of the n client PCs 20 applies the energy-saving policy to the corresponding client PC 20 in accordance with the delivered energy-saving policy. That is, each of the n client PCs 20 is set in an energy-saving state based on the energy-saving policy.

The agent 203 of each of the n client PCs 20 monitors the configuration state and operation state of the corresponding client PC 20, and records an energy-saving measurement log (log information) in the energy-saving measurement log storage area 20e (block B109). The energy-saving function monitoring module 20c of the client PC 20 includes the following functions: (i) a function of acquiring a model name of a PC, (ii) a function of acquiring a type of a CPU incorporated in a PC, (iii) a function of detecting the monitor-on time, and monitor-off time of a PC, (iv) a function of detecting the HDD motor-off time, and HDD motor-on time of a PC, (v) a function of detecting the system-standby start time, and restoration time of a PC, (vi) a function of detecting the system-pause start time, and restoration time of a PC, (vii) a function of detecting the system-startup time, and shutdown time of a PC, (viii) a function of monitoring a keyboard operation and mouse operation carried out by the user of a PC, and detecting the non-operation start time and non-operation end time in units of minutes. Each agent 203 periodically transmits a log to the policy delivery server 10. It should be noted that the agent 203 acquires configuration information and an operation state of the client PC 20 from the OS 202 or the like provided in the client PC 20 (block B103).

The data configuration of the energy-saving measurement log is shown in FIG. 6. The log comprises (1) a model name of a PC, (2) CPU type, (3) monitor-on/off time, (4) HDD motor-on/off time, (5) system-standby start/restoration time, (6) system-pause start/restoration time, (7) system-startup/shutdown time, and (8) user non-operation start/non-operation end time.

The model name denotes the model name of the client PC. The CPU type denotes the type of CPU incorporated in the client PC 20. The monitor-on/off time denotes the time at which the monitor power supply is turned on or is turned off. The HDD motor-on/off time denotes the time at which the HDD motor is turned on or is turned off. The system-standby start/restoration time denotes the time at which the system is shifted to the standby state or is restored from the standby state. The system-pause start/restoration time denotes the time at which the system is shifted to the pause state or is restored from the pause state. The system-startup/shutdown time denotes the time at which the PC is started or is shut down. The user non-operation start time/non-operation end time denotes the time at which the keyboard operation or mouse operation ceases to be carried out or is started.

It should be noted that although in the above-mentioned example, eight data items are made the contents of the energy-saving measurement log, it is sufficient if the data items can be monitored by the agent 203, and the number of data items and data contents are not to be limited.

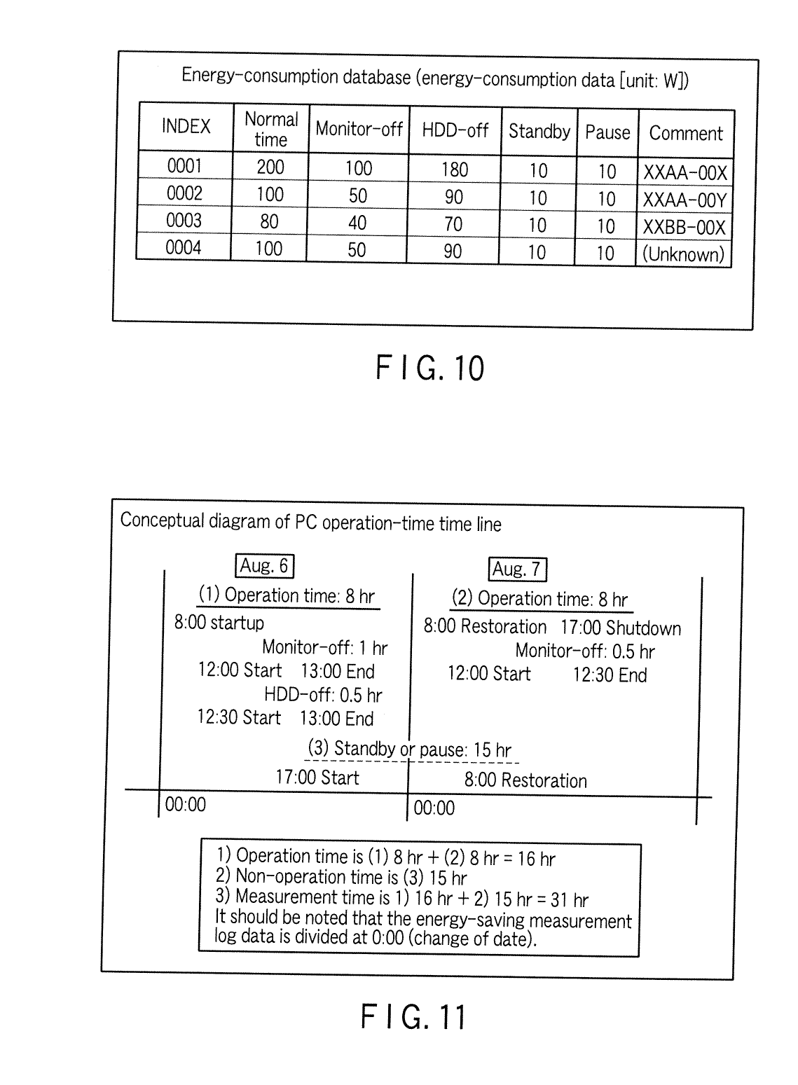

The agent 203 periodically transmits an energy-saving measurement log to the policy delivery server 201. The policy delivery server 201 determines the energy consumption (actual result value) of the client PC 20 from the log collected from the agent 203, and data of the PC energy-consumption database 10e (block B104). The PC energy-consumption database 10e includes a table of the energy-consumption values (energy consumption at the normal operation time, energy consumption at the monitor-off time, energy consumption at the HDD motor-off time, energy consumption at the standby time, and energy consumption at the pause time) as shown in FIG. 10. Furthermore, the PC energy consumption database 10e includes a table of indexes of energy consumption values associated with the model names (machine IDs) as shown in FIG. 8, and table of indexes of energy consumption values associated with the CPU type names as shown in FIG. 9.

In block B104, the energy consumption of the client PC 20 is determined by the policy delivery server 10 in the following manner. That is, the energy-consumption control application 201 acquires information (energy-saving measurement log: log information) on the client PC 20 from the client PC 20. The energy-consumption control application 201 acquires information (model name and CPU type name) concerning the client PC 20 based on the acquired log information, reads a set value (energy-saving setting information: energy-saving policy) associated with the model name and CPU type name from the PC energy-consumption database 10e (FIGS. 8 to 10), and saves the read value in the policy storing module 10b as an energy-saving policy. The above-mentioned processing is repetitively carried out for each of the client terminals.

By carrying out processing with a light load, i.e., reading energy-consumption data associated with the model name of the client PC 20, and CPU type name from the PC energy-consumption database 10e, the energy consumption of the client PC 20 is determined, and hence it is possible to lighten the load on the policy delivery server 10. It should be noted that the PC energy-consumption determination module 10f saves the determined energy consumption (energy-saving policy) in the policy storing module 10b as an energy-saving policy to apply the energy consumption (energy-saving policy) to a corresponding client PC 20. It should be noted that the detailed processing of the determination of the energy consumption of the client PC 20 will be described later. As described above, the energy consumption determination of the client PC 20 to be carried out by the policy delivery server 10 is carried out by automatic setting processing, hence the user's work is lightened, and it is not necessary for the user to determine the set value, thereby making the troublesome work unnecessary.

Subsequently, the energy-consumption control application 201 of the policy delivery server 10 carries out display of the PC energy consumption, and display (PC energy consumption/CO₂ emission amount calculation display) of the CO₂ emission amount (block B105). Calculation and display of the CO₂ emission amount will be described later in detail.

When the display of the energy consumption of the client PC is to be carried out, the energy-consumption control application 201 selects one of displaying the actual result value of the energy consumption, and displaying the predicted value of the energy consumption (block B106). When the actual result value of the energy consumption is selected by the user in block B106, the energy-consumption control application 201 carries out graph display of the actual result value of the energy consumption (block B107: to be described later). On the other hand, when the predicted value of the energy consumption is selected by the user in block B106, the energy-consumption control application 201 carries out graph display of the predicted effect value of the energy consumption (block B108: to be described later). As described above, by carrying out the effect prediction processing, it is possible to confirm in advance energy-consumption reduction in the case where a predetermined energy-saving policy is employed. As a result of this, it becomes possible for the user to examine the plan before the predetermined energy-saving policy is employed.

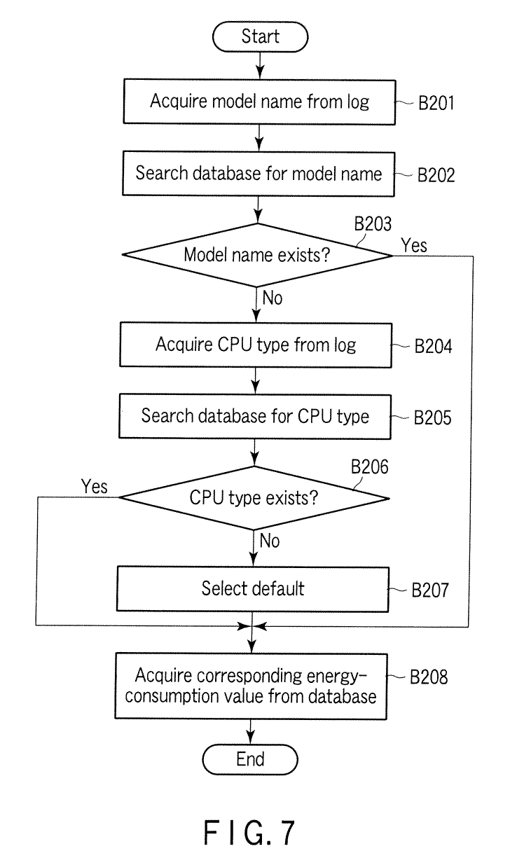

FIG. 7 is a flowchart showing the processing of the energy consumption determination of the client PC 20 to be carried out by the policy delivery server 10 (corresponding to block B104 of FIG. 4).

The energy-consumption control application 201 of the policy delivery server 10 acquires the model name of the client PC 20 based on a log received from the client PC 20 (block B201). The energy-consumption control application 201 searches the energy-consumption database 10e to confirm whether or not the acquired model name exists in the energy-consumption database 10e (FIG. 8) (block B202). In block B203, when it is determined by the energy-consumption control application 201 that the acquired model name exists in the energy-consumption database 10e (YES in block B203), by acquiring a corresponding energy-consumption value (energy-saving policy) from the energy-consumption database 10e, the energy-saving policy (energy-consumption control to be applied to the client PC 20) corresponding to the model name is determined (block B208).

On the other hand, in block B203, when it is determined by the energy-consumption control application 201 that the acquired model name does not exist in the energy-consumption database 10e (NO in block B203), the energy-consumption control application 201 acquires the CPU type of the client PC 20 based on the log received from the client PC 20 (block B204). The energy-consumption control application 201 searches the energy-consumption database 10e to confirm whether or not the acquired CPU type exists in the energy-consumption database 10e (FIG. 9) (block B205). In block B206, when it is determined by the energy-consumption control application 201 that the acquired CPU type exists in the energy-consumption database 10e (YES in block B206), by acquiring a corresponding energy-consumption value (energy-saving policy) from the energy-consumption database 10e, the energy-saving policy (energy-consumption control to be applied to the client PC 20) corresponding to the model name is determined (block B208).

On the other hand, in block B206, when it is determined by the energy-consumption control application 201 that the acquired CPU type does not exist in the energy-consumption database 10e (NO in block B206), the default of the energy-saving policy stored in the energy-consumption database 10e is selected (block B207). The energy-consumption control application 201 acquires a corresponding energy-consumption value (default of the energy-saving policy) from the energy-consumption database 10e, whereby the energy-saving policy (energy-consumption control to be applied to the client PC 20) corresponding to the model name is determined (block B208).

Each of FIGS. 8 to 10 is a view schematically showing an example of a database to be stored in the above-mentioned energy-consumption database 10e. FIG. 8 is a model search list in the energy-consumption database 10e. As shown in FIG. 8, for example, a machine ID (model name) and INDEX are associated with each other to be stored. FIG. 9 is a CPU performance search list in the energy-consumption database 10e. As shown in FIG. 9, for example, a CPU-TYPE (CPU type) and INDEX are associated with each other to be stored. FIG. 10 is a list of energy-consumption data (energy-consumption value) in the energy-consumption database 10e. As shown in FIG. 10, for example, the above-mentioned INDEX, and energy-consumption values of the client PC 20 in the several states are associated with each other to be stored. The states of the client PC 20 imply, for example, the normal state, monitor-off state, HDD motor-off state, standby state, and pause state.

For example, in the above-mentioned flowchart, when it is determined in block B203 by the energy-consumption control application 201 that the model name (for example, XXAA-00X) exists, the INDEX of the energy-consumption value (energy-saving policy) corresponding to the model name (XXAA-00X) is 0001 (FIG. 8). That is, the normal time (200 W), monitor-off state (100 W), HDD motor-off state (180 W), standby state (10 W), and pause state (10 W) are obtained. Further, when it is determined in block B206 by the energy-consumption control application 201 that the CPU type (for example, XXAA-200) exists, the INDEX of the energy-consumption value (energy-saving policy) corresponding to the CPU type (XXAA-200) is 0002 (FIG. 9). That is, the normal time (100 W), monitor-off state (50 W), HDD motor-off state (90 W), standby state (10 W), and pause state (10 W) are obtained. Furthermore, when it is determined in block B206 by the energy-consumption control application 201 that the CPU type (for example, XXAA-300) does not exist, the INDEX of the energy-consumption value (energy-saving policy) is 0004 which is the default (FIG. 9). That is, the normal time (100 W), monitor-off state (50 W), HDD motor-off state (90 W), standby state (10 W), and pause state (10 W) are obtained.

Next, FIG. 11 is a view showing a totalizing method for totalizing up the time during which the energy-saving function is exerted in the PC to which energy-saving setting is applied based on the energy-saving policy from the log information stored in the energy-saving measurement log storage area 20e.

Based on the above-mentioned log information, the energy-consumption control application 201 measures the accumulated monitor-off time by calculating a time difference from the monitor-off time and monitor-on time. Further, the energy-consumption control application 201 measures the accumulated HDD motor-off time by calculating a time difference from the HDD motor-off time and HDD motor-on time. Furthermore, the energy consumption control application 201 measures the accumulated pause time by calculating a time difference from the pause start time and restoration time. Further, the energy-consumption control application 201 measures the accumulated standby time by calculating a time difference from the standby start time and restoration time.

Furthermore, the energy-consumption control application 201 measures the operation time of the client PC 20 by regarding the first start-up, standby restoration, and pause restoration of the client PC 20 on and after 0:00 of the agent as the operation start, by regarding the last shutdown, standby and pause of the client PC 20 on and before 0:00 as the operation end, and by calculating a time difference. Further, the policy delivery server 10 calculates the normal operation time by subtracting the accumulated monitor-off time, accumulated HDD motor-off time, accumulated standby time, and accumulated pause time from the operation time of the client PC 20. Subsequently, the energy-consumption control application 201 calculates the energy-consumption amount based on each collected accumulated time and energy consumption. The calculated energy-consumption amount is converted into the CO₂ emission amount.

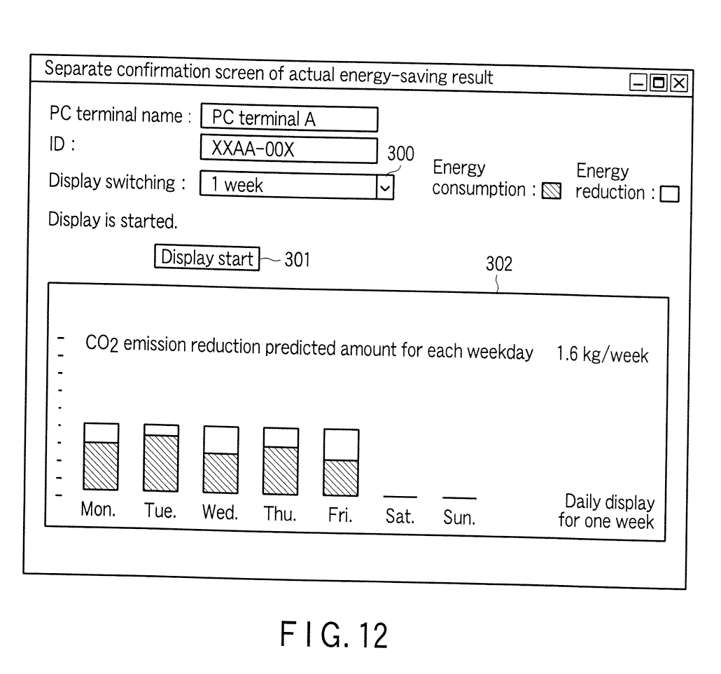

An example in which a certain client PC 20 has a model name of “XXAA-00X”, energy-saving setting as shown in FIG. 11 is applied to the client PC 20 from August 6 (Mon.) to August 7 (Tue.), and energy-saving actual result as shown in FIG. 12 is displayed will be described below.

An energy-saving measurement log is recorded by the agent of the client PC 20 as shown in FIG. 11. It should be noted that (a) to (j) are symbols added for convenience of explanation. Parenthesized numerals such as (7), and the like are numbers indicating types of logs in FIG. 6 described above.

That is, the symbols and numerals are used to express: (a) Aug. 6, 8:00 system startup (7), (b) Aug. 6, 12:00 monitor-off (3), (c) Aug. 6, 12:30 HOD motor-off (4), (d) Aug. 6, 13:00 HDD motor-on (4), (e) Aug. 6, 13:00 monitor-on (3), (f) Aug. 6, 17:00 standby start (5), (g) Aug. 7, 8:00 standby restoration (5), (h) Aug. 7, 12:00 monitor-off (3), (i) Aug. 7, 12:30 monitor-on (3), (j) Aug. 7, 17:00 shutdown (7).

As described above, based on a model name “XXAA-00X” of a certain client PC 20, the energy-consumption control application 201 of the policy delivery server 10 searches the model search list, and determines that energy-consumption data of INDEX=0001 corresponds to the model name (FIG. 10). Further, the operation time of Aug. 6 is (f)−(a)=8 [hr]. Further, as shown in FIG. 10, the energy consumption in a case where energy-saving setting is not carried out on Aug. 6 (at the normal time: INDEX=0001) is calculated at

200 [W]×8 [hr]=1600 [Wh].

In the actual energy-saving effect, the monitor-off time is (e)−(b)=1 [hr] as shown in FIG. 10, energy consumption reduction resulting therefrom is calculated as follows. The rate of energy consumption at the monitor-off time is 100 W, and hence the energy consumption at the normal time is obtained by subtracting the amount from 200 W as follows. (200 [W]−100 [W])×1 [hr]=100 [Wh] Furthermore, likewise, the HDD-off time is (d)−(c)=0.5 [hr], energy reduction resulting from this is (200[W]−180 [W])×0.5 [hr]=10 [Wh], total energy reduction (energy contributing to energy saving) is 100 [Wh]+10 [Wh]=110 [Wh], and actual energy consumption is calculated by the policy delivery server 10 at 1600 [Wh]−110 [Wh]=1490 [Wh].

FIG. 12 is a view showing the case where the above-mentioned actual energy-saving result (separate confirmation screen of actual energy-saving result) is formed into a graph (corresponding to block B107 of FIG. 4). The actual energy-saving result is displayed in the display area 302 by switching, for example, the display for each week, display for each month, and the like by using a pull-down menu 300, and pressing the display-start button 301. That is, when for example, Aug. 6 is Monday, the hatched part (energy consumption) of Monday is displayed as 1490 [Wh], and non-hatched part (energy reduction) is displayed as 110 [Wh].

Likewise, in the case of Aug. 7, the operation time is calculated at (j)−(g)=8 [hr], and energy consumption of the case where energy-saving setting is not applied is calculated at 200 [W]×8 [hr]=1600 [Wh]. Further, as for the actual energy-saving effect, the monitor-off time is (i)−(h)=0.5 [hr], and energy reduction resulting from this is (200 [W]−100 [W]×0.5 [hr]−50 [Wh], and actual energy consumption is calculated at 1600 [Wh]−50 [Wh]=1550 [Wh]. When, for example, Aug. 7 is Tuesday, by forming the data into a graph, the hatched part of Tuesday is displayed as 1550 [Wh], and non-hatched part is displayed as 50 [Wh] as shown in FIG. 12. Likewise, with respect to other weekdays too, the actual energy consumption and energy reduction are calculated and formed into a graph.

Furthermore, the CO₂ emission amount can be obtained as a calculated conversion value by multiplying the measured energy consumption (kWh) by an emission factor (0.555). First, the policy delivery server 10 calculates the energy consumption and energy reduction for one week in the same manner as the above calculation. When the total of the energy reduction for one week is 2800 [Wh], the conversion is carried out as 2.8 [kWh]×0.555=1.6 [kg/week], thereby converting the energy reduction into the CO₂ emission amount.

After the operation is started, when the energy-saving effect is to be predicted by changing the set value, the existing energy-saving measurement log data is corrected by using the set value after the change, and effect prediction value graph is displayed.

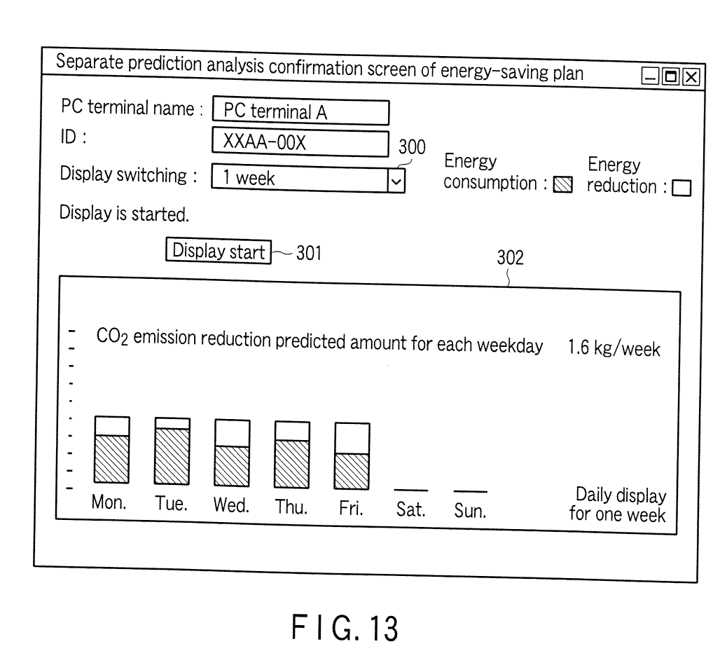

FIG. 13 is a view showing the case where the above-mentioned energy-saving prediction (separate prediction analysis confirmation screen of the energy-saving scheme) is formed into a graph (corresponding to block B108 of FIG. 4).

The case where, for example, with respect to a certain client PC 20 (model name “XXAA-00X”), in a period from Aug. 6 (Mon.) to Aug. 7 (Tue.), the operation shown in FIG. 11 is changed to a certain extent will be described below. The energy-saving policy to be applied to the operation shown in FIG. 11 is (1) monitor-off time: 60 min. (1 hr), (2) HDD motor-off time: 30 min. (0.5 hr), (3) system standby time: 100 min., (4) system pause time: no setting.

The effect prediction of the energy reduction of the case where among the policy items, (1) monitor-off time: 60 min. (1 hr) is changed to (1) monitor-off time: 5 min. is calculated in the following manner. That is, monitor-off is changed to be carried out after an elapse of 5 minutes from the non-operation start time (k) or (m). The monitor-off time of Aug. 6 is (e)−(k)+5 [min.]=1.9 [hr], energy reduction resulting from this is (200 [W]−100 [W]×1.9 [hr]=190 [Wh], and actual energy consumption is calculated at 1600 [Wh]−190 [Wh]=1410 [Wh]. Further, the monitor-off time of Aug. 7 is (i)−(m)+5 [min.]=1.4 [hr], energy reduction resulting from this is (200 [W]−100 [W]×1.4 [hr]=140 [Wh], and actual energy consumption is calculated at 1600 [Wh]−140 [Wh]=1460 [Wh]. The effect prediction of the energy reduction of the case where among the energy-saving policy items, (1) monitor-off time: 60 min. (1 hr) is changed to (1) monitor-off time: 5 min. is calculated in the manner described above. As shown in FIG. 13, a graph is formed by addition of the above-mentioned reduction-prediction energy consumption. When the user has changed the energy-saving policy, it is possible to confirm the prediction analysis in which the ratio of the energy reduction (non-hatched part) is greater than the graph based on the actual energy consumption shown in FIG. 12.

Further, as described above, the CO₂ emission amount can be obtained as a calculated conversion value by multiplying the measured energy consumption (kWh) by an emission factor (0.555). In the same manner as the above calculation, the policy delivery server 10 calculates the energy consumption and energy reduction for one week and, when the total of the energy reduction for one week is 3300 [Wh], the server 10 converts the energy reduction into the CO₂ emission amount by the calculation of 3.3 [kWh]×0.555=1.8 [kg/week]. By carrying out the calculation in the manner described above, it is possible to visualize and confirm the prediction of the energy reduction and the like of the case where the energy-saving policy is applied.

According to the first embodiment described above, it is possible to control the energy consumption of the client terminal, and reduce the processing load of the server apparatus. Further, by virtue of the visualization (forming into a graph) of the prediction of the effect (degree) of the energy-saving setting, it becomes possible to confirm and select the energy-saving policy which is the appropriate set value without repeating the application of the energy-saving policy and calculation of the actual energy consumption.

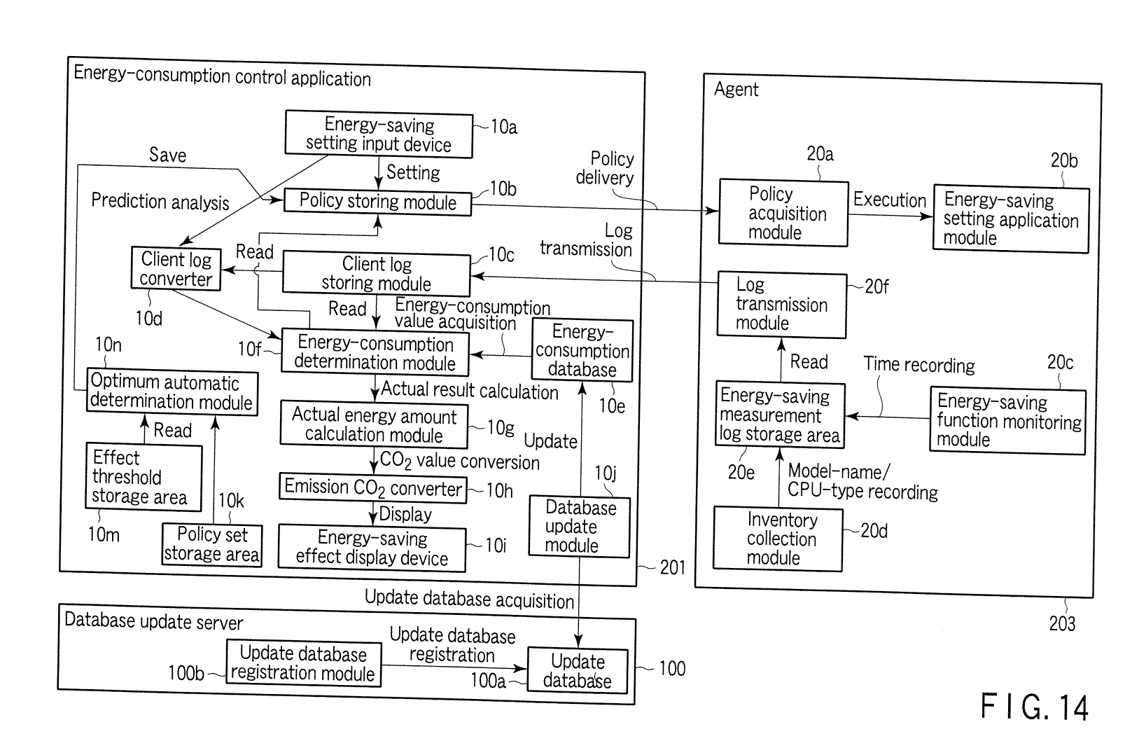

Next, the configuration of an energy-consumption control system including an information processing apparatus according to a second embodiment will be described below with reference to FIG. 14. This embodiment is further provided with, in addition to the configuration of the above-mentioned first embodiment, a policy set storage area 10k, effect threshold storage area 10m, and optimum policy automatic determination module 10n. It should be noted that configurations identical with the first embodiment are denoted by reference symbols identical with the first embodiment, and a detailed description of them is left to the previous description. According to this embodiment, the operation of a site is started in accordance with a certain energy-saving policy, and thereafter an energy-saving policy appropriate to the system is automatically determined.

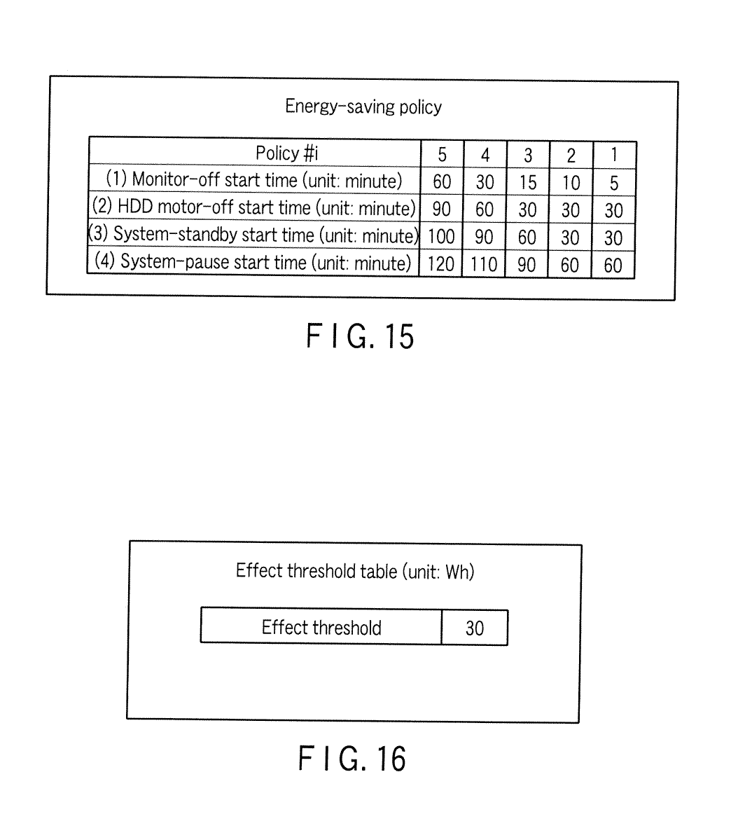

The policy set storage area 10k stores therein a plurality of energy-saving policies (energy-saving setting information set) in which set values are different from each other. For example, an example in which five policies are stored as shown in FIG. 15 will be described. It is assumed that a policy #i indicates an ith policy. The smaller the value of i, the smaller the set value of each item of the policy, and hence it is assumed that the effect (degree) of energy-consumption reduction becomes greater correspondingly. The effect threshold storage area 10m is a storage area in which an effect threshold is stored. The effect threshold is a threshold for determining, when the energy-saving policy is changed, and an effect thereof is calculated, if the changed policy is effective. For example, as shown in FIG. 16, an effect threshold is stored as 30 Wh. The optimum policy automatic determination module 10n calculates a predicted value in a case where the above-mentioned policy is employed, and determines the optimum energy-saving policy by checking presence/absence of an effect based on the effect threshold.

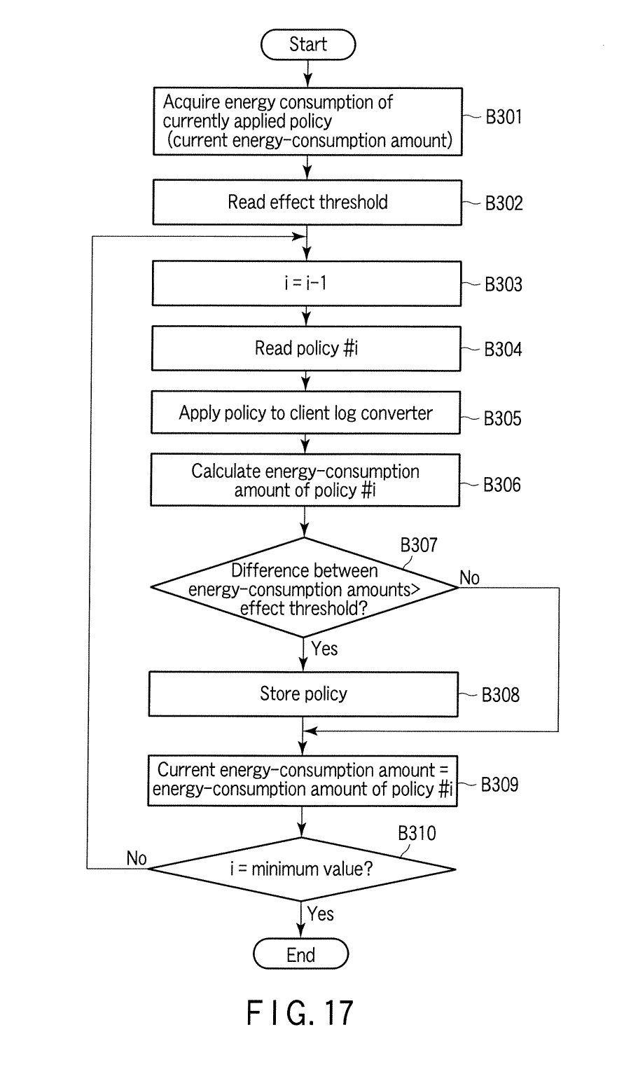

Next, an energy-consumption control method using an energy-consumption control system according to the second embodiment including an information processing apparatus, and configured as described above will be described below with reference to the flowchart of FIG. 17.

An energy-consumption control application 201 of a policy delivery server 10 acquires an energy-consumption amount of the currently employed energy-saving policy, and makes the amount an initial value of the current energy-consumption amount (block B301). Subsequently, the energy-consumption control application 201 reads an effect threshold from the effect threshold storage area 10m (block B302). Then, the energy-consumption control application 201 carries out loop processing (block B303 to block B310) while reducing the value i of the policy from the maximum value (“i=maximum value”) toward the minimum value (“i=minimum value”) by one at a time.

The energy-consumption control application 201 carries out the following processing items in the loop processing. That is, the energy-consumption control application 201 first sets the maximum value (i=maximum value) (block B303). Subsequently, the energy-consumption control application 201 reads the energy-saving policy #i to start calculation of a predicted value (block B304). The energy-consumption control application 201 applies the policy to a client log converter 10d (block B305). The energy-consumption control application 201 calculates an energy-consumption amount of policy #i by referring to the energy-saving policy shown in FIG. 15 (block B306). The energy-consumption control application 201 determines whether or not a difference between the current energy-consumption amount calculated in block B301, and energy consumption amount of policy #i calculated in block B306 is greater than the effect threshold (block B307). When it is determined in block B307 by the energy-consumption control application 201 that the difference is greater than the effect threshold (YES in block B307), policy #i is temporarily stored in the energy-consumption control application 201 as an application candidate (block B308), and the flow is shifted to block B309. On the other hand, when it is determined in block B307 by the energy-consumption control application 201 that the difference is less than or equal to the effect threshold (NO in block B307), the energy-consumption control application 201 makes the current energy-consumption amount the energy-consumption amount of policy #i (current energy-consumption amount=energy-consumption amount of policy #i) irrespectively of the size-relationship between the difference and effect threshold (block B309). The energy-consumption control application 201 determines whether or not i is the minimum value (i=minimum value) (block B310). When it is determined in block B310 by the energy-consumption control application 201 that i is the minimum value (i=minimum value), the processing is ended. In this case, policy #i temporarily stored as the candidate is made the optimum policy.

On the other hand, when it is determined in block B310 by the energy-consumption control application 201 that i is not the minimum value (I≠minimum value), the flow returns to block B303, and the application 201 continues carrying out the loop processing (block B303 to block B310) while reducing i by one at a time. That is, energy-consumption control application 201 selects an energy-saving policy in such a manner that the degree of energy-consumption reduction of a predetermined client terminal becomes greater than the threshold, and the greatest, and delivers the selected energy-saving policy to the corresponding client terminal. By the processing described above, it becomes possible to automatically determine an appropriate policy for each operation site, and further reduce the management cost of the user.

Next, the second embodiment will be described below more specifically with reference to FIGS. 11, 15, and 16. As shown in, for example, FIG. 15, a case where the optimum policy is to be obtained when policies of i=5 to 1, and an effect threshold (FIG. 16) are set, will be described below.

For example, when policy #5 is applied to a client PC 20 (model name “XXAA-00X”), and an operation of FIG. 11 is carried out on Aug. 6, the energy-consumption control application 201 determines the optimum energy-saving policy by the following operation.

That is, the energy-consumption control application 201 first calculates the monitor-off time (e)−((k)+60 [min.])=1 [hr] of Aug. 6. Subsequently, the energy-consumption control application 201 calculates the energy reduction (200 [W]−100 [W])×1 [hr]=100 [Wh] resulting from the monitor-off time. Further, the energy-consumption control application 201 calculates the HDD-off time (d)−((k)+90 [min.])=0.5 [hr]. Subsequently, the energy-consumption control application 201 calculates the energy reduction (200 [W]−180 [W]×0.5 [hr]=10 [Wh] resulting from the HDD-off time. Further, the energy-consumption control application 201 calculates the total energy reduction 100 [Wh]+10 [Wh]=110 [Wh] and, when the current energy reduction is 110 [Wh], calculates the effect of the case where the policy is changed to policy #5 at 110 [Wh]−110 [Wh]=0 [Wh]. Further, the energy-consumption control application 201 determines whether or not the effect is greater than the effect threshold 30 [Wh] (FIG. 16). The effect 0 [Wh] is less than 30 [Wh], and hence it is determined that no effect of application is obtained.

Subsequently, the energy-consumption control application 201 applies policy #4 in the same manner, and carries out the following calculation. That is, the monitor-off time of Aug. 6 is (e)−((k)+30 [min.])=1.5 [hr], energy reduction resulting from this is (200 [W]−100 [W])×1.5 [hr]=150 [Wh], HDD-off time is (d)−((k)+60 [min.])=1 [hr], energy reduction resulting from this is (200 [W]−180 [W])×1 [hr]=20 [Wh], total energy reduction is 150 [Wh]+20 [Wh]=170 [Wh], effect of the case where policy #5 is changed to policy #4 is 170 [Wh]−110 [Wh]=60 [Wh], and all the above calculation results are obtained by the energy-consumption control application 201. The above value 60 [Wh] is greater than the effect threshold 30 [Wh] (FIG. 16), and hence the energy-consumption control application 201 determines that an effect of the application can be obtained, and stores the policy temporarily.

Subsequently, the energy-consumption control application 201 applies policy #3 in the same manner, and carries out the following calculation. That is, the monitor-off time of Aug. 6 is (e)−((k)+15 [min.])=1.8 [hr], energy reduction resulting from this is (200 [W]−100 [W])×1.8 [hr]=180 [Wh], HDD-off time is (d)−((k)+30 [min.])=1.5 [hr], energy reduction resulting from this is (200 [W]−180 [W])×1.5 [hr]=30 [Wh], total energy reduction is 180 [Wh]+30 [Wh]=210 [Wh], effect of the case where policy #4 is changed to policy #3 is 210 [Wh]−170 [Wh]=40 [Wh], and all the above calculation results are obtained by the energy-consumption control application 201. The above value 40 [Wh] is greater than the effect threshold 30 [Wh] (FIG. 16), and hence the energy-consumption control application 201 determines that an effect of the application can be obtained, and stores the policy temporarily.

Subsequently, the energy-consumption control application 201 applies policy #2 in the same manner, and carries out the following calculation. That is, the monitor-off time of Aug. 6 is (e)−((k)+10 [min.])=1.8 [hr], energy reduction resulting from this is (200 [W]−100 [W])×1.8 [hr]=180 [Wh], HDD-off time is (d)−((k)+30 [min.])=1.5 [hr], energy reduction resulting from this is (200 [W]−180 [W])×1.5 [hr]=30 [Wh], total energy reduction is 180 [Wh]+30 [Wh]=210 [Wh], effect of the case where policy #3 is changed to policy #2 is 210 [Wh]−210 [Wh]=0 [Wh], and all the above calculation results are obtained by the energy-consumption control application 201. The above value 0 [Wh] is less than the effect threshold 30 [Wh] (FIG. 16), and hence the energy-consumption control application 201 determines that no effect of the application can be obtained.

Subsequently, the energy-consumption control application 201 applies policy #1 in the same manner, and carries out the following calculation. That is, the monitor-off time of Aug. 6 is (e)−((k)+5 [min.])=1.9 [hr], energy reduction resulting from this is (200 [W]−100 [W])×1.9 [hr]=190 [Wh], HDD-off time is (d)−((k)+30 [min.])=1.5 [hr], energy reduction resulting from this is (200 [W]−180 [W])×1.5 [hr]=30 [Wh], total energy reduction is 190 [Wh]+30 [Wh]=220 [Wh], effect of the case where policy #2 is changed to policy #1 is 220 [Wh]−210 [Wh]=10 [Wh], and all the above calculation results are obtained by the energy-consumption control application 201. The above value 10 [Wh] is less than the effect threshold 30 [Wh] (FIG. 16), and hence the energy-consumption control application 201 determines that no effect of the application can be obtained.

The above-mentioned contents are rearranged in the following manner to be described.

The energy reduction of the case where the current policy is applied is 110 [Wh].

When policy #5 is applied, the energy reduction is 110 [Wh]: the difference between this and the reduction of the current policy is 0 [Wh], and the difference is less than 30 [Wh], and hence it is determined that no effect of the application is obtained.

When policy #4 is applied, the energy reduction is 170 [Wh]: the difference between this and the reduction of policy #5 becomes 60 [Wh], and the difference is greater than 30 [Wh], and hence it is determined that an effect of the application is obtained. The total energy reduction which is the difference between the above value and the current policy is 0+60 [Wh].

When policy #3 is applied, the energy reduction is 210 [Wh]: the difference between this and the reduction of policy #4 becomes 40 [Wh], and the difference is greater than 30 [Wh], and hence it is determined that an effect of the application is obtained. The total energy reduction which is the difference between the above value and the current policy is 60+40=100 [Wh].

When policy #2 is applied, the energy reduction is 210 [Wh]: the difference between this and the reduction of policy #3 becomes 0 [Wh], and the difference is less than 30 [Wh], and hence it is determined that no effect of the application is obtained.

When policy #1 is applied, the energy reduction is 220 [Wh]: the difference between this and the reduction of policy #3 becomes 10 [Wh], and the difference is less than 30 [Wh], and hence it is determined that no effect of the application is obtained.

That is, the policies for each of which it is determined by the energy-consumption control application 201 that an application effect is obtained are policy #3 and policy #4. Among these policies, the policy energy reduction of which is the largest is policy #3 the energy reduction of which is 100 [Wh]. As a result of carrying out the calculation up to 1 (i=1), the energy-consumption control application 201 determines that policy #3 which provides a difference greater than the threshold, and the largest total energy reduction is the most appropriate for the operation of the client PC 20 (model name “XXAA-00X”).

It should be noted that the example described above is an example in which the energy-consumption control application 201 applies a policy to an energy-saving measurement log of one client PC for one day to carry out determination. When there are a plurality of client PCs, the energy-consumption control application 201 calculates an effect in a case where policy #i is applied to all the client PCs in the same manner, and carries out determination by comparing the average value and effect threshold with each other. Furthermore, when there is a log of an amount for two days or more, the energy-consumption control application 201 applies a policy also to a past log in the same manner, calculates an average value, and compares the average value with the effect threshold.

By employing the second embodiment described above, it is possible to automatically select and apply an optimum energy-saving policy which provides a predetermined reduction effect of energy consumption.

Further, the above-mentioned energy-consumption control application 201 may be configured to be incorporated in the OS 202 as a function of the OS 202. Furthermore, the energy-consumption control application 201 may be stored in a “computer-readable storage medium”.

According to this embodiment, it is possible to control the energy consumption of a client terminal, and reduce the processing load of an information processing apparatus.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus connectable to a client terminal, the apparatus comprising:
a storage configured to store energy-consumption setting information of the client terminal in association with information relating to the client terminal;
an acquisition module configured to acquire client terminal information from the client terminal;
a read module configured to read the information relating to the client terminal from the storage based on the acquired client terminal information, and to read the energy-consumption setting information in association with the information relating to the client terminal; and
a control module configured to deliver the read energy-consumption setting information to the client terminal in order to carry out an energy consumption control for the client terminal.

2. The apparatus of claim 1, wherein the information associated with the client terminal comprises a model name of the client terminal and a type of a CPU of the client terminal.

3. The apparatus of claim 1, wherein
the client terminal information comprises log information indicating an operation state of the client terminal, and
the control module is configured to calculate an energy consumption of the client terminal based on the log information.

4. The apparatus of claim 3, wherein the control module is configured to display a graph of the energy consumption of the client terminal in a case where the energy-consumption setting information is applied to the client terminal, and the calculated energy consumption of the client terminal.

5. The apparatus of claim 3, wherein the control module is configured to display a graph of predicted energy consumption of the client terminal in a case where the energy-consumption setting information is applied to the client terminal and the calculated energy consumption of the client terminal.

6. The apparatus of claim 1, wherein the control module is configured to calculate predicted energy consumption in a case where predetermined energy-consumption setting information stored in the storage is applied to the client terminal before the predetermined energy-consumption setting information is delivered by the control module to the client terminal.

7. The apparatus of claim 6, wherein the control module is configured to calculate predicted energy consumptions for client terminals and to calculate an average value of the calculated predicted energy consumptions.

8. The apparatus of claim 1, wherein
the storage is configured to store energy-consumption setting information items of the client terminal in association with information relating to the client terminal, and a threshold of energy consumption, and
the control module is configured to select one of the energy-consumption setting information items such that total energy reduction is maximum and a change in the total energy reduction in a case where the energy-consumption setting information item applied to the client terminal is changed to the one of the energy-consumption setting information items is greater than the threshold of energy consumption.

9. An energy-consumption control method comprising:
storing in a storage energy-consumption setting information of a client terminal in association with information relating to the client terminal;
acquiring client terminal information from the client terminal;
reading the information relating to the client terminal from the storage based on the acquired client terminal information;
reading the energy-consumption setting information in association with the information relating to the client terminal; and
delivering the read energy-consumption setting information to the client terminal in order to carry out an energy consumption control for the client terminal.

10. The method of claim 9, wherein the information associated with the client terminal comprises a model name of the client terminal and a type of a CPU of the client terminal.

11. The method of claim 9, wherein
the client terminal information comprises log information indicating an operation state of the client terminal, and
an energy consumption of the client terminal is calculated based on the log information.

12. The method of claim 11, further comprising displaying a graph of the energy consumption of the client terminal in a case where the energy-consumption setting information is applied to the client terminal, and the calculated energy consumption of the client terminal.

13. The method of claim 11, further comprising displaying a graph of predicted energy consumption of the client terminal in a case where the energy-consumption setting information is applied to the client terminal, and the calculated energy consumption of the client terminal.

14. The method of claim 9, further comprising calculating predicted energy consumption in a case where predetermined energy-consumption setting information stored in the storage is applied to the client terminal before the predetermined energy-consumption setting information is delivered to the client terminal.

15. The method of claim 14, further comprising calculating predicted energy consumptions for client terminals and calculating an average value of the calculated predicted energy consumptions.

16. The method of claim 9, further comprising:
storing energy-consumption setting information items of the client terminal in association with information relating to the client terminal, and a threshold of energy consumption, and
selecting one of the energy-consumption setting information items such that total energy reduction is maximum and a change in the total energy reduction in a case where the energy-consumption setting information item applied to the client terminal is changed to the one of the energy-consumption setting information items is greater than the threshold of energy consumption.
